(19) United States
(12) Patent Application Publication
(10) Pub. No.: US 2013/0199976 A1
(43) Pub. Date: Aug. 8, 2013

(54) MEMBRANE DISTILLATION MODULE

(71) Applicant: Korea Institute of Science and Technology, Seoul (KR)

(72) Inventors: Seong Pil JEONG, Seoul (KR); Seockheon LEE, Seoul (KR)

(73) Assignee: KOREA INSTITUTE OF SCIENCE AND TECHNOLOGY, Seoul (KR)

(21) Appl. No.: 13/687,262

(22) Filed: Nov. 28, 2012

(30) Foreign Application Priority Data
Feb. 2, 2012 (KR) 10-2012-0010907

(51) Int. Cl. C02F 1/44

(52) U.S. Cl. CPC C02F 1/447; B82Y 99/00
USPC 210/138; 210/180; 977/742; 977/734; 977/902

(57) ABSTRACT

A membrane distillation module is provided. The membrane distillation module includes a feed water side, a membrane, and a treated water side. A heating element is mounted in the feed water side. The membrane distillation module may optionally further include a heat spreading element. The heat spreading element is mounted in contact with the heating element to improve the efficiency of heat diffusion to the membrane.

### CROSS-REFERENCE TO RELATED APPLICATIONS

This application claims priority under 35 U.S.C. §119 to Korean Patent Application No.10-2012-0010907 filed on Feb. 2, 2012, in the Korean Intellectual Property Office, the disclosure of which is incorporated herein by reference in its entirety.

### BACKGROUND OF THE INVENTION

1. Field of the Invention

The present invention relates to a membrane module based on membrane distillation for water treatment.

2. Description of the Related Art

Membrane distillation is a process in which a phase change occurs on the surface of a hydrophobic polymer membrane, and vapor passes through surface micropores of the membrane and is then condensed. Membrane distillation is in desalting processes for separating and removing non-volatile or relatively low volatile matter. Membrane distillation can also be used to separate highly volatile organic substances from aqueous solutions.

Since the concept of membrane distillation was introduced in 1940, recent major research on membrane distillation has been conducted in the United States, Europe, Japan and Australia. In recent years, membrane distillation processes have received considerable attention as potential replacements for conventional separation processes based on evaporation or the use of reverse osmosis membranes.

Evaporation and reverse osmosis requiring a large quantity of energy are currently used for pure water production or seawater desalination. Particularly, reverse osmosis involves multiple pretreatment stages before use to avoid the problems of contamination and fouling, which causes difficulty in terms of operation and management. Further, high-pressure operation of reverse osmosis systems needs the use of much electrical energy as a power source for pumps, leading to an increase in maintenance expense.

The use of porous membranes enables the operation of membrane distillation at a lower pressure than ultrafiltration and reverse osmosis. Membrane distillation utilizes a partial vapor pressure difference across a membrane for separation. Membrane distillation is free of the problem of entrainment encountered in the separation and removal of non-volatile substances, like salts, and eliminates the use of filters or membranes that require high operational pressure, unlike traditional distillation processes.

Due to these advantages, low cost of utility and high durability of separation systems are ensured in seawater desalination (desalting) based on membrane distillation. Therefore, membrane distillation is emerging as a competitive process for drink production throughout the world.

Membrane distillation uses a hydrophobic polymer membrane. A solvent or a solute (as a hydrophilic substance) in a liquid state cannot pass through pores in the membrane and is repelled from the membrane surface due to its larger surface tension than that of the membrane. A substance to be purified undergoes a phase conversion to vapor at the entrances of the surface pores of the membrane. Thereafter, the vapor-phase substance is diffused into the pores, permeates the membrane, and is finally condensed.

Such membrane distillation is carried out using a membrane module including a feed water side where a feed solution passes through a membrane, and a treated water side where a substance to be purified is condensed.

Despite the above-mentioned advantages, membrane distillation essentially uses thermal energy to create a vapor pressure difference between the feed water side and the treated water side. Taking into consideration the fact that thermal energy makes up the largest portion of the total operational expense of the membrane module, this energy cost burden makes membrane distillation economically disadvantageous over other water treatment processes.

In membrane distillation, it is also important to continuously keep the vapor pressure difference. To this end, the temperature difference between the feed water and the treated water is maintained at a constant level. Therefore, effective transfer of heat to the membrane distillation module has a great influence on the water treatment performance of membrane distillation.

There is thus a need to develop a membrane distillation technology that can minimize loss of thermal energy during membrane distillation to contribute to energy saving and enables effective delivery of thermal energy to a membrane module to achieve improved water treatment performance.

### Prior Art Document

Japanese Unexamined Patent Publication No. 1995-000768

### SUMMARY OF THE INVENTION

An object of the present invention is to provide a membrane distillation module designed such that raw water entering a feed water side is prevented from losing its heat during feeding from the outside, which is a problem of conventional membrane distillation modules, heat is supplied to the raw water in the feed water side in an efficient and uniform manner, contributing to thermal energy saving, and the yield of treated water is increased.

According to an aspect of the present invention, there is provided a membrane distillation module. More specifically, the membrane distillation module includes a feed water side, a membrane, and a treated water side wherein a heating element is mounted in the feed water side.

The membrane distillation module may optionally further include a heat spreading element mounted in contact with the heating element to improve the efficiency of heat diffusion to the membrane.

The membrane distillation module of the present invention is not limited to a particular type and may be, for example, of either submerged or pressurized type. The membrane distillation module of the present invention may be applied to any distillation processes, for example, direct contact membrane distillation (DCMD), air gap membrane distillation (AGMD), vacuum membrane distillation (VMD), and sweep gas membrane distillation (SGMD).

The feed water side of the membrane distillation module is an area through which raw water entering from the outside passes. When raw water enters from the outside and passes through the feed water side, vapor present in the raw water passes through the membrane and reaches the treated water side due to a vapor pressure difference between the feed water side and the treated water side.

The raw water is not particularly limited so long as it needs to be purified to produce pure water therefrom. The raw water may be, for example, foul water, wastewater or seawater. The membrane distillation module is constructed such that the temperature of the raw water in the feed water side is higher than that of treated water in the treated water side. Due to this construction, a vapor pressure difference is created between the feed water side and the treated water side. The temperature difference is not particularly limited but is preferably not larger than 600° C. in terms of energy efficiency and pure water yield.

For higher vapor permeability, it would be desirable to increase the temperature of the feed water side as high as possible. An increase in the temperature of the feed water leads to an increased vapor pressure at the feed water side, resulting in a large vapor pressure difference between the feed water side and the treated water side, which acts as a driving force for vapor permeation through the membrane.

The membrane distillation module of the present invention may be constructed such that the flow of the raw water entering the feed water side may be repeatedly stopped for predetermined periods of time to increase the production of pure water. After the flow of the feed water is stopped and a sufficient amount of pure water is obtained, the remaining portion of the raw water in the module is discharged to the outside of the module and fresh raw water is supplied to the feed water side. Then, the flow of the fresh raw water is again stopped. This procedure is performed repeatedly.

Alternatively, the raw water may be allowed to enter continuously and the remaining portion thereof after concentration may be discharged at a constant flow rate. And a constant flow rate can be changed or determined intentionally during the membrane distillation process. In this case, membrane distillation using the module may be run in such a manner that the concentrated water is discharged after the module is operated for a certain time or the concentration of the concentrated water is increased above a predetermined level.

As described above, the membrane distillation module of the present invention is constructed such that feed water is allowed to flow at predetermined time intervals instead of maintaining a continuous flow of feed water. This construction offers the advantage that energy required to operate a pump adapted to flow feed water into the feed water side can be saved compared to conventional membrane distillation modules.

The heating element is mounted at one side of the feed water side of the module to effectively transfer heat to the membrane through the feed water side. According to a conventional membrane distillation technique, raw water is preheated and enters a membrane module from the outside, losing its heat. This heat loss leads to deterioration of energy efficiency. In contrast, in the module of the present invention, raw water is allowed to enter without being preheated from the outside and is directly heated by the heating element positioned at one side of the feed water side, so that loss of the heat to the outside can be minimized. The feed water side may be designed to have a narrowly defined space. This design allows for a local supply of heat from the heating element to the membrane, so that thermal energy consumed by the feed water in the feed water side can be reduced compared to a conventional module including a feed water side having a larger space.

Any heating element may be used that can generate heat due to its high resistivity when electricity is supplied from the outside. There is no particular restriction on the kind of the heating element. Examples of heating elements suitable for use in the module include metal heating elements and non-metal heating elements commonly used in the art. The metal heating elements may be those made of pure metals and alloys. The pure metals may be, for example, molybdenum (Mo), tungsten (W) and platinum (Pt). The alloys may be, for example, nichrome (Ni-Cr), ferrochrome (Fe-Cr) and Fe-Cr-Al. The non-metal heating elements may be those made of silicon carbide (SiC), molybdenum silicide (MoSi₂), lanthanum chromite (LaCrO₂), graphite, and zirconia (ZrO₂). Other examples of suitable heating elements include ceramic heating elements and barium carbonate heating elements.

The heating element may have any shape that can efficiently and uniformly supply heat to the entire region of the membrane in contact with the feed water side. For example, the heating element may be planar or linear in shape. The volumes of the feed water side and the treated water side between which the membrane is disposed may vary depending on the membrane distillation conditions.

If needed, the membrane distillation module of the present invention may be designed such that the space of the feed water side adapted to accommodate feed water is smaller than that of the treated water side adapted to accommodate treated water. This design enables faster heating of the feed water entering the module. The ratio of the space of the feed water side to that of the treated water side is not particularly limited but is preferably from 1:1.01 to 1:100. If the space of the treated water side is smaller than the lower limit (1:1.01), the effect of shortening the time required to heat the raw water in the feed water side is substantially negligible, compared to when the space ratio is 1:1. Meanwhile, if the space of the treated water side exceeds the upper limit (1:100), that is, the space of the feed water side is excessively small, it may be difficult to obtain the desired amount of purified water.

The membrane distillation module of the present invention may further include a heat spreading element. The heat spreading element plays a role in uniformly diffusing heat supplied from the heating element into the feed water in the module. The heat spreading element is preferably one that has a large surface area and is made of a highly thermally conductive material to enable uniform and effective transfer of heat supplied from the heating element to the feed water in the module. Examples of highly thermally conductive materials for the heat spreading element include metal materials, such as iron, copper and aluminum, carbon nanotubes, graphene, and fullerene. The heat spreading element may have any shape that allows for effective and uniform diffusion of heat to all portions of the feed water flowing in the module. For example, the heat spreading element may have a wool, a mesh network or honeycomb structure. This structure has a large specific surface area and acts as a resistance against a flow of feed water to some extent to further lengthen the retention time of the feed water in the module, ensuring uniform supply of heat to all portions of the feed water in the module. The long retention time of the feed water can guarantee a more concentrated and efficient supply of heat to the feed water in the module and can bring about a temperature rise of the feed water without substantial loss of the thermal energy supplied.

No particular limitation is imposed on the position of the heat spreading element mounted in the module of the present invention. It is preferred that the heat spreading element is positioned in close contact with the heating element. This position allows for maximum transfer of heat supplied from the heating element. The heat spreading element may be made of the same material as the heating element. The heat spreading element may be processed in a state in which it is not separated from the heating element.

In the membrane distillation module of the present invention, the membrane is preferably made of a hydrophobic polymer. The reasons for the use of the hydrophobic polymer as a material for the membrane are to prevent a solvent or a solute (a hydrophilic substance) in a liquid state having a larger surface tension than that of the membrane from passing through the pores in the membrane and to repel the solvent or solute from the membrane surface. Another reason is because the substance to be purified having undergone a phase conversion to vapor at the entrances of the surface pores of the membrane is diffused into the pores, permeates the membrane, and is finally condensed in the treated water side.

The hydrophobic polymer membrane may be made of any hydrophobic polymer for water treatment. Examples of such hydrophobic polymers include polytetrafluoroethylene (PTFE), polyvinylidene fluoride (PVDF), polysulfone (PSF), polyethersulfone (PES), polyetherimide (PEI), polyimide (PI), polyethylene (PE), polypropylene (PP), and polyamide (PA). These hydrophobic polymers may be used alone or as a mixture thereof.

The treated water side is an area where vapor escaping from the membrane is condensed and flows. In the treated water side, pure water is collected as treated water separated from the raw water. The treated water in the treated water side has a lower temperature than the feed water.

As described above, the heating element is provided in the feed water side of the membrane distillation module to directly supply heat to feed water in the space of the feed water side in contact with the membrane. Therefore, feed water entering the feed water side can be prevented from losing its heat during feeding from the outside, which is a problem of conventional membrane distillation modules, and the consumption of thermal energy generated from the heating element in spaces other than the space of the feed water side near the membrane, which is another problem of conventional membrane distillation modules, can be reduced.

In addition, feed water is not continuously circulated but is allowed to stay in the module at predetermined time intervals, so that thermal energy generated from the heating element can be sufficiently delivered to the feed water in the module. Therefore, the production of pure water can be improved. Furthermore, the operation of a raw water circulation pump can be minimized, resulting in a reduction in the amount of energy supplied to the pump.

The membrane distillation module of the present invention further includes a heat spreading element having a large specific surface area and made of a highly thermally conductive material, in addition to the heating element. The heat spreading element enables an efficient supply of heat to feed water in the feed water side and a uniform supply of heat to all portions of the feed water in the module, leading to a high yield of treated water relative to thermal energy consumed.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the structure of a membrane distillation system including a membrane distillation module according to an embodiment of the present invention;

FIG. 2 illustrates the structure of the membrane distillation system of FIG. 1, in which a raw water supply pump is not included;

FIG. 3 illustrates the structure of a membrane distillation system including a membrane distillation module according to another embodiment of the present invention; and

FIG. 4 illustrates the structure of the membrane distillation system of FIG. 3, in which a raw water supply pump is not included;

### DETAILED DESCRIPTION OF THE INVENTION

Embodiments of the present invention will now be described in detail with reference to the accompanying drawings. However, these embodiments are provided for illustrative purposes only and are not intended to limit the scope of the invention.

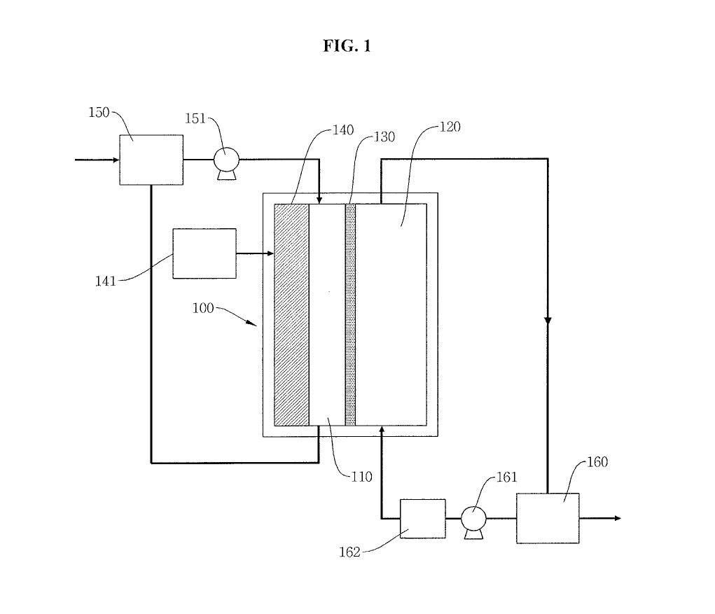

FIG. 1 illustrates the structure of a membrane distillation system including a membrane distillation module according to an embodiment of the present invention. Referring to FIG. 1, the membrane distillation module 100 includes a feed water side 110, a treated water side 120, and a membrane 130.

A planar heating element 140 is mounted at one side of the feed water side 110. The planar heating element 140 receives electrical energy from an external power source 141 to generate heat.

The feed water side 110 of the membrane distillation module 100 is an area where raw water entering from the outside stays. During stay of the raw water in the feed water side 110, a vapor pressure difference between the feed water side 110 and the treated water side 120 causes vapor present in the raw water to reach the treated water side 120 through the membrane 130.

The raw water entering the feed water side 110 and staying in a space near the membrane 130 receives thermal energy generated from the planar heating element 140 and is then heated. At this time, pure water contained in the raw water is vaporized in the feed water side 110, resulting in a rise in the pressure of vapor at the feed water side 110.

With reference to FIG. 1, a detailed description will be given concerning the operation of the membrane distillation module.

First, raw water stored in a raw water storage tank 150 is sent to the feed water side 110 of the membrane distillation module 100 by a raw water circulation pump 151. As illustrated in FIG. 1, the operation of the raw water circulation pump 151 may be stopped to block the feeding of the raw water when the raw water fills up the feed water side 110 or may be continued to circulate the raw water. Next, the raw water filled in the feed water side 110 receives thermal energy generated from the planar heating element 140 mounted at one side of the feed water side 110 and is then heated, so that pure water contained in the heated raw water is vaporized, resulting in a rise in the pressure of vapor at the feed water side 110. The treated water side 120 of the membrane distillation module 100 is an area where treated water circulates and passes continuously. The treated water is allowed to flow to the membrane distillation module 100 from a treated water storage tank 160 by a treated water circulation pump 161. During the circulation, the treated water is cooled by a cooling device 162 and sent to the treated water side 120 of the membrane distillation module 100. The treated water is continuously circulated, and a portion of the treated water stored in the treated water storage tank 160 is released to the outside and is used as pure water. The temperature difference between the feed water side 110 and the treated water side 120 creates a vapor pressure difference between both sides. The vapor pressure difference causes vapor of pure water contained in the raw water of the feed water side 110 to pass through the membrane 130 and to reach the treated water side 120. The low temperature of the treated water side 120 enables condensation of the vapor as pure water. Hydrophobicity of the membrane 130 prevents liquids other than the vapor of pure water from passing through the membrane 130 from the feed water side 110.

After sufficient purification of the raw water staying in the feed water side 110, the remaining portion of the raw water in the feed water side 110 is discharged to the outside of the membrane distillation module 100. Then, the raw water circulation pump 151 is again operated to supply fresh raw water to the feed water side 110 from the raw water storage tank 150. This procedure is repeated. Upon continuous operation, fresh raw water is fed into the raw water storage tank 150 to control the concentration of the raw water in the raw water storage tank 150. After the raw water in the raw water storage tank 150 is sufficiently concentrated, the raw water concentrate is removed from the raw water storage tank 150 and fresh raw water is supplied to the raw water storage tank 150.

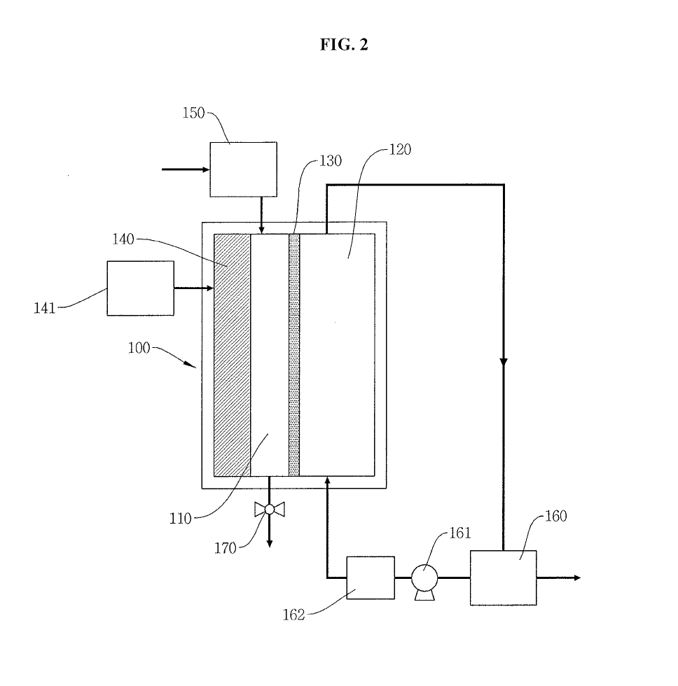

FIG. 2 illustrates the structure of the membrane distillation system of FIG. 1, in which the raw water supply pump is not included. As the water purification proceeds, the raw water in the feed water side 110 is concentrated. At this time, a valve 170 can be opened such that the raw water staying in the feed water side 110 is discharged to the outside of the module and fresh raw water is continuously fed into the feed water side 110 from the raw water storage tank 150 by the gravitational force. In this embodiment, energy required to operate the raw water supply pump can be effectively saved.

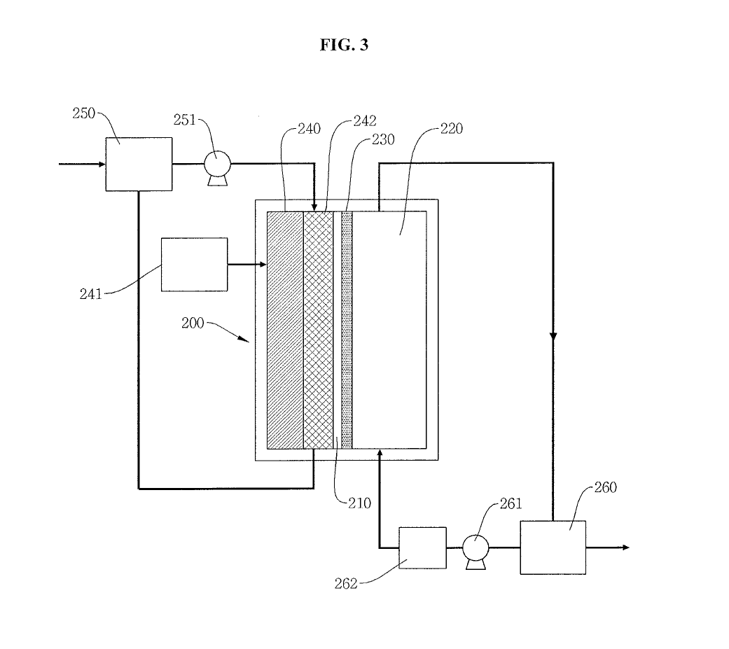

FIG. 3 illustrates the structure of a membrane distillation module according to another embodiment of the present invention. Referring to FIG. 3, the membrane distillation module 200 includes a feed water side 210, a treated water side 220, and a membrane 230.

A planar heating element 240 is mounted at one side of the feed water side 210. The planar heating element 240 receives electrical energy from an external power source 241 to generate heat.

A heat spreading element 242 is located in close contact with the planar heating element 240. The heat spreading element 242 has a mesh network structure and a high thermal conductivity.

Raw water entering the feed water side 210 and staying in a space near the membrane 230 receives thermal energy generated from the planar heating element 240 through the heat spreading element 242 and is then heated. The heat spreading element 242 plays a role in uniformly and efficiently diffusing the heat into all portions of the raw water in the feed water side 210 due to its high thermal conductivity and large specific surface area, so that pure water contained in the raw water can be more uniformly vaporized in the feed water side 210, resulting in a rise in the pressure of vapor at the feed water side 210.

With reference to FIG. 3, a detailed description will be given concerning the operation of the membrane distillation module.

First, raw water stored in a raw water storage tank 250 is sent to the feed water side 210 of the membrane distillation module 200 by a raw water circulation pump 251. The operation of the raw water circulation pump 251 may be stopped to block the feeding of the raw water when the raw water fills up the feed water side 210 or may be continued to circulate the raw water. The raw water circulation pump 251 may be omitted if necessary. Next, the raw water filled in the feed water side 210 receives thermal energy generated from the planar heating element 240 mounted at one side of the feed water side 210 through the heat spreading element 242 and is then heated, so that pure water contained in the heated raw water is vaporized, resulting in a rise in the pressure of vapor at the feed water side 210. The treated water side 220 of the membrane distillation module 200 is an area where treated water circulates and passes continuously. The treated water is allowed to flow to the membrane distillation module 200 from a treated water storage tank 260 by a treated water circulation pump 261. During the circulation, the treated water is cooled by a cooling device 262 and sent to the treated water side 220 of the membrane distillation module 200. The treated water is continuously circulated, and a portion of the treated water stored in the treated water storage tank 260 is released to the outside and is used as pure water. The temperature difference between the feed water side 210 and the treated water side 220 creates a vapor pressure difference between both sides. The vapor pressure difference causes vapor of pure water contained in the raw water of the feed water side 210 to pass through the membrane 230 and to reach the treated water side 220. The low temperature of the treated water side 220 enables condensation of the vapor as pure water. Hydrophobicity of the membrane 230 prevents liquids other than the vapor of pure water from passing through the membrane 230 from the feed water side 210.

After sufficient purification of the raw water staying in the feed water side 210, the remaining portion of the raw water in the feed water side 210 is discharged to the outside of the membrane distillation module 200. Then, the raw water circulation pump 251 is again operated to supply fresh raw water to the feed water side 210 from the raw water storage tank 250. This procedure is repeated.

Upon continuous operation, fresh raw water is fed into the raw water storage tank 250 to control the concentration of the raw water in the raw water storage tank 250. After the raw water in the raw water storage tank 250 is sufficiently concentrated, the raw water concentrate is removed from the raw water storage tank 250 and fresh raw water is supplied to the raw water storage tank 250.

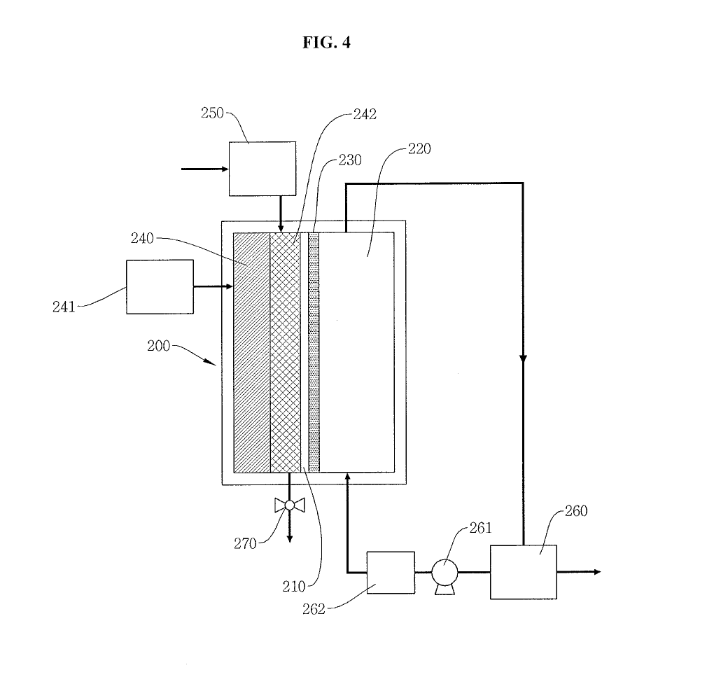

FIG. 4 illustrates the structure of the membrane distillation system of FIG. 3, in which the raw water supply pump is not included. As the water purification proceeds, the raw water in the feed water side 210 is concentrated. At this time, a valve 270 can be opened such that the raw water staying in the feed water side 210 is discharged to the outside of the module and fresh raw water is continuously fed into the feed water side 210 from the raw water storage tank 250 by the gravitational force. In this embodiment, energy required to operate the raw water supply pump can be effectively saved.

It will be understood by those skilled in the art that the invention can be implemented in other specific forms without changing the spirit or essential features of the invention. The scope of the invention is defined by the appended claims rather than the detailed description of the invention. All changes or modifications or their equivalents made within the meanings and scope of the claims should be construed as falling within the scope of the invention.

What is claimed is:

1. A membrane distillation module comprising a feed water side, a membrane, and a treated water side wherein a heating element is mounted in the feed water side.

2. The membrane distillation module according to claim 1, wherein the heating element is a metal heating element or a non-metal heating element.

3. The membrane distillation module according to claim 2, wherein the metal heating element is a pure metal heating element or an alloy heating element.

4. The membrane distillation module according to claim 3, wherein the pure metal heating element is made of a metal selected from the group consisting of molybdenum (Mo), tungsten (W) and platinum (Pt).

5. The membrane distillation module according to claim 3, wherein the alloy heating element is made of an alloy selected from the group consisting of nichrome (Ni-Cr), ferrochrome (Fe-Cr) and Fe-Cr-Al.

6. The membrane distillation module according to claim 2, wherein the non-metal heating element is made of a non-metal selected from the group consisting of silicon carbide (SiC), molybdenum silicide (MoSi₂), lanthanum chromite (LaCrO₂), graphite, and zirconia (ZrO₂).

7. The membrane distillation module according to claim 1, wherein the heating element is made of ceramic or barium carbonate.

8. The membrane distillation module according to claim 1, further comprising a heat spreading element mounted in contact with the heating element.

9. The membrane distillation module according to claim 8, wherein the heat spreading element is made of a metal material.

10. The membrane distillation module according to claim 8, wherein the heat spreading element is made of a material selected from the group consisting of carbon nanotubes, graphene, and fullerene.

11. The membrane distillation module according to claim 1, wherein the membrane distillation module is of submerged or pressurized type.

12. The membrane distillation module according to claim 1, wherein the temperature difference between the feed water side and the treated water side is not larger than 600° C.

13. The membrane distillation module according to claim 1, wherein the membrane is a hydrophobic polymer membrane.

14. The membrane distillation module according to claim 13, wherein the hydrophobic polymer membrane is made of at least one polymer selected from the group consisting of polytetrafluoroethylene (PTFE), polyvinylidene fluoride (PVDF), polysulfone (PSF), polyethersulfone (PES), polyetherimide (PEI), polyimide (PI), polyethylene (PE), polypropylene (PP), and polyamide (PA).

15. The membrane distillation module according to claim 1, wherein the ratio of the space of the feed water side to that of the treated water side is from 1:1.01 to 1:100.

16. The membrane distillation module according to claim 1, wherein the flow of feed water entering the feed water side is repeatedly stopped for predetermined periods of time.
